(19) United States
(12) Patent Application Publication
(10) Pub. No.: US 2007/0129469 A1
(43) Pub. Date: Jun. 7, 2007

(54) Dye based on at least one polymer dispersion and method for application of the dye

(75) Inventors: Uwe Befurt, Ober-Ramstadt (DE); Thomas Hummert, Modautal (DE); Erhard Bister, Gross-Zimmern (DE); Harald Sauseng, Ostrach (DE); Jurgen Stecher, Mariabrunn (DE); Viktor Sorg, Salem (DE); Heike Zoller, Kressbronn (DE); Rolf Mazenauer, Widnau (CH)

Correspondence Address: MCDONNELL BOEHNEN HULBERT & BERGHOFF LLP, 300 S. WACKER DRIVE, 32ND FLOOR, CHICAGO, IL, 60606, US

(73) Assignees: Deutsche Amphibolin-Werke von Robert Murjahn Stiftung & Co. KG, Ober-Ramstadt (DE); J. Wagner GmbH, Markdorf (DE)

(21) Appl. No.: 10/551,730

(22) PCT Filed: Apr. 2, 2004
(86) PCT No.: PCT/EP04/03530

§ 371 Date: Oct. 5, 2006

(30) Foreign Application Priority Data
Apr. 4, 2003 (DE) 103 15 483.3

(51) Int. Cl. B05D 7/00; C08K 5/34; C08K 3/22

(52) U.S. Cl. 524/88; 427/421.1; 524/430

(57) ABSTRACT

The present invention relates to a paint based on at least one polymer dispersion with pigments, fillers, thickeners, dispersants and additives, said paint containing: a) 2-20 wt-% polymer dispersion calculated as a solid component, b) 2-35 wt-% pigments, c) 5-60 wt-% fillers having a particle diameter of 0.1-200 μm d) 0.1-3 wt-% thickeners, e) 0.1-2 wt-% dispersants, and a maximum of 5 wt-% additives and water to make up to 100%,
with the proviso that the dispersion has a viscosity of 2.0 to 5·10² m Pa/s, the viscosity being determined at a shear rate of 30,000·1/s with a capillary rheometer.

Paints based on at least one polymer dispersion comprising a plastics dispersion, pigments and fillers, are a widely used coating system in the prior art for coating backgrounds of all types, especially internal and external walls in the construction industry. The general properties of the dispersion, but also of the finished products produced therefrom, are predominately determined by the respective polymer. Up to now such dispersion paints have usually been applied to the background by application means which are known per se, such as rollers or paint brushes. Applying such dispersion paints by means of a spray gun is already known in the prior art.

It has emerged that when dispersion paints are applied with a spray gun, especially the mist which is thereby produced in the form of fine droplets causes problems during application. Firstly the mist produced leads to it not being possible to realise exact coatings, i.e. no coatings can be realised in which a sharply defined spray pattern can be produced, and secondly the mist arising here also leads to health problems since the fine mists which arise with the usual spray methods using the known dispersion paints of the prior art and which have dimensions <15 μm lead to stress on the health of the people using them.

Proceeding from this, the object of the present invention is to propose a paint based on at least one polymer dispersion which makes it possible for the paint to be applied using a spray gun in a way which is as free of mist as possible. It is simultaneously the object of the present invention to quote an appropriate method.

This object is accomplished in respect of the paint by the characterising features of patent claim 1 and in respect of the application method by the characterising features of patent claim 11. The subordinate claims list advantageous developments.

The paint according to the invention, hereinafter referred to as a “dispersion paint”, accordingly comprises a polymer dispersion, pigments, fillers, a thickener and dispersants and additives, the viscosity of this dispersion paint being set at 2.0 to 5·10² m Pa/s. The viscosity was measured at a shear rate of 30,000·1/s using a capillary rheometer. Such a method for determining viscosity is described for example in R. W. Whorlov: Rheological Techniques, Publishers Elis Horwood, N.Y., 1992.

According to the present invention, it is essential for the dispersion paint that the range for the viscosity quoted in claim 1 be adhered to. It has become apparent that only a dispersion paint having such a composition and such a viscosity, when applied using a spray gun, leads to droplets which are not below a specific minimum size, and this produces a defined spray pattern. The paint according to the invention has furthermore the advantage that, with it, breathing in spray mist is avoided to the largest extent.

In the case of the dispersion paint according to the invention, care must be taken to ensure that the composition quoted in claim 1 in respect of the polymer dispersion is adhered to. According to the present invention, provision is made for the paint to contain 2-20 wt-% polymer dispersion calculated as a solid component, 2-35 wt-% pigments, 5-60 wt-% fillers having a particle diameter of 0.1 to 200 μm, 0.1-3 wt-% thickeners, 0.1-2 wt-% dispersants and a maximum of up to 5 wt-% additives. In experiments the applicant was able to demonstrate that it is quite particularly preferred for the viscosity to be in the range between 3.5 and 5·10² m Pa/s.

From the point of view of the material, it is preferred for the dispersion paint according to the invention that the polymer dispersion be selected from polymers which are built up from specific monomers. Suitable monomers are for example carboxylic acid vinyl esters having 3 to 20 carbon atoms, especially vinyl acetate, vinyl propionate and carboxylic acid vinyl esters having 9 to 11 carbon atoms in the carboxylic acid component, furthermore N-vinylpyrrolidone and its derivatives, ethylenically unsaturated carboxylic acids, their esters, amides or anhydrides, and furthermore α-olefins, especially ethylene and propylene as well as acrylonitrile. Particularly preferred is the use of ethylenically unsaturated carboxylic acids, especially acrylic acid and methacrylic acid, furthermore the use of ethylenically unsaturated carboxylic acid esters, especially acrylic and methacrylic acid esters having 1 to 12 carbon atoms in the alcohol residue. The alcohol residue of the esters can comprise linear or branched alkyl chains, cycloaliphatics or aromatics which can be additionally modified with hydroxyl groups, halogen atoms or epoxy groups. The use of styrene and styrene derivatives is also particularly preferred.

The pigments known from the prior art can actually be used as the pigments here. Examples of these are titanium dioxide, iron oxide, chromium oxide, cobalt blue, phthalocyanine pigments, spinel pigments and nickel and chromium titanate. Organic pigments such as azoic pigments, quinacridone pigments and/or dioxazine pigments can also be used. It has proved to be particularly advantageous if titanium dioxide is used as the pigment. As fillers, silicates, carbonates, fluorite, sulphates and oxides can be considered. By particular preference the fillers are kaolin, mica, talcum and calcium carbonate. It is also preferred for the above-mentioned fillers to be used in the form of a mixture. It has been demonstrated that it is particularly advantageous if the fillers have a diameter of 0.1 to 200 μm, by particular preference 0.1 to 100 μm. The selection of the particle size of the fillers is obviously also important for setting the viscosity. It is here also possible to use a bimodal particle-size distribution in addition to a monomodal particle-size distribution. A further preferred variant for controlling the viscosity of the paint according to the invention consists in the surfaces of the filler particles being functionalised. As “functionalised filler particles” according to the present invention are understood those in which the functional groups are bound to the surface both via a covalent bond or by simple interactions. Particles which have been subsequently treated, e.g. with a water-repellent coating, can also be used.

In the paint according to the invention it is furthermore essential that a thickener be used. The thickener is used according to the present invention at a rate of 0.1-3 wt-%. From the point of view of material, in particular all those polycarboxylate thickeners known in the prior art are possible as thickeners here. Examples of these are polycarboxylates, urethane thickeners, polysaccharides and cellulose ethers.

The dispersion paint according to the invention can naturally, as already known from the prior art, contain additives in an amount of up to 5 wt-%. Examples of such additives are dispersants, stabilisers, anti-foaming agents, preservatives and/or hydrophobing agents.

It is essential now that the dispersion paint, as described above, is excellently suitable for being applied by means of a spraying method. According to the present invention, the procedure here is that the dispersion paint is led from a reservoir, preferably a paint container, via a conveying unit and a connecting line to an airless spray gun. It is important here that the spraying pressure which is set here is 50-135 bar, preferably 70-80 bar, measured at the spray gun. Thus obviously all the characteristic quantities which are necessary for spraying, such as nozzle diameter d, lamellar thickness l, mean exit velocity u, viscosity υ as well as the surface tension σ and the density ρ are favourably influenced. Thus on average larger droplets are produced for the method according to the invention compared with airless spraying methods which are known per se, and very high application efficiency rates of up to 99%.

It is advantageous in the method according to the invention, if a diaphragm pump is used as the conveying device. It has also proved to be advantageous if the connecting line, e.g. in the form of a hose, can be heated. In this way it can be ensured that the dispersion paint can be guided from the reservoir, i.e. from the paint container, by the conveying unit to the spraying device substantially independently of the ambient temperature. It is advantageous here for the temperature to be set in the range between 27 and 40° C., especially between 30 and 38° C. The process must be so managed that the above-mentioned temperatures are achieved at the spray gun. This ensures that the outstanding properties of the dispersion paint, as explained above, are preserved.

It is particularly surprising here that, despite the high pressures used in this method and the temperature, the positive physical properties, i.e. in particular the high viscosity, are substantially not impaired.

It has proved to be a further advantageous factor if the airless spray gun used is equipped with a double nozzle. The arrangement of the design of the double nozzles should here be so selected that the spray jets intersect in the longitudinal direction. To this end, double nozzles in the form of two slit-like nozzle apertures arranged in a row are to be regarded as particularly advantageous.

The invention relates furthermore to the use of the above-described dispersion paint for applying the paint by means of an airless spraying method.

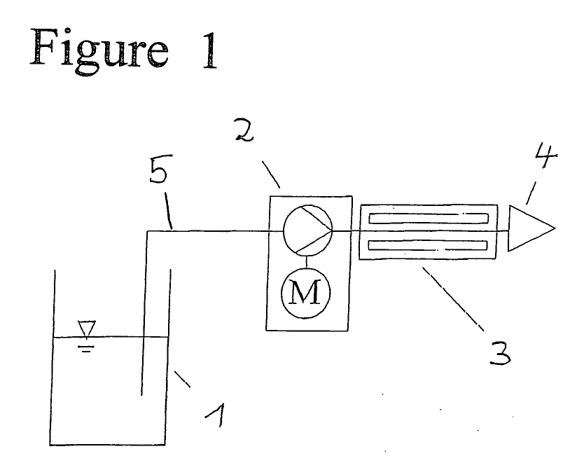

The invention is explained in greater detail below with the aid of a starting formulation and FIGS. 1 to 5.

FIG. 1 here shows the schematic structure of a device for accomplishing the method according to the invention;

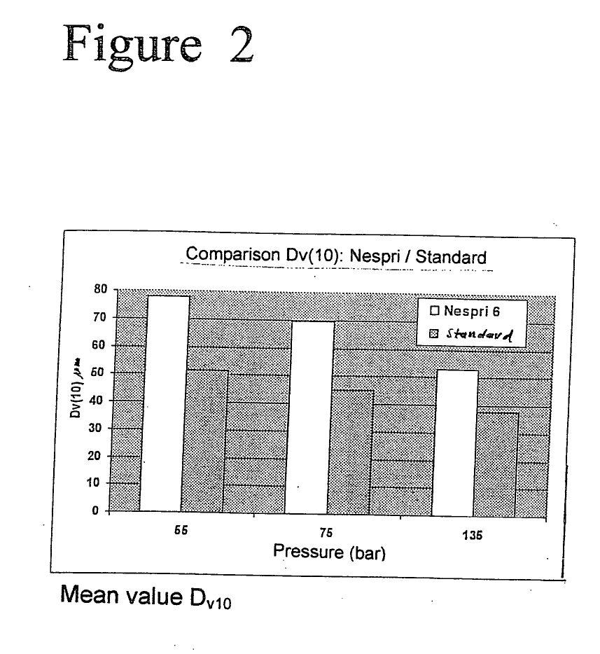

FIG. 2 shows the comparison between the paint according to the invention and a paint of the prior art in respect of the mean droplet size;

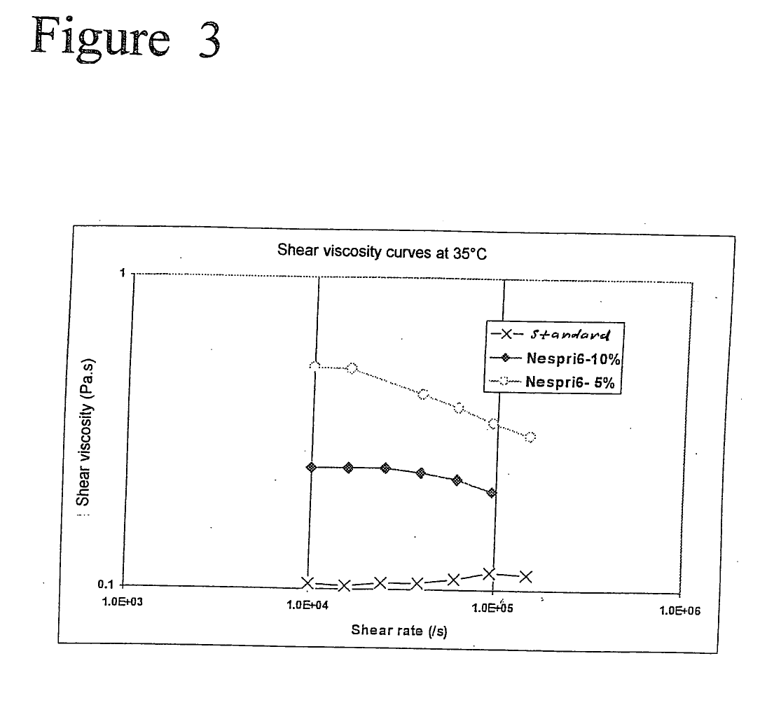

FIG. 3 shows the viscosity of the paint according to the invention in two dilution stages with a paint of the prior art in a predetermined shear rate range;

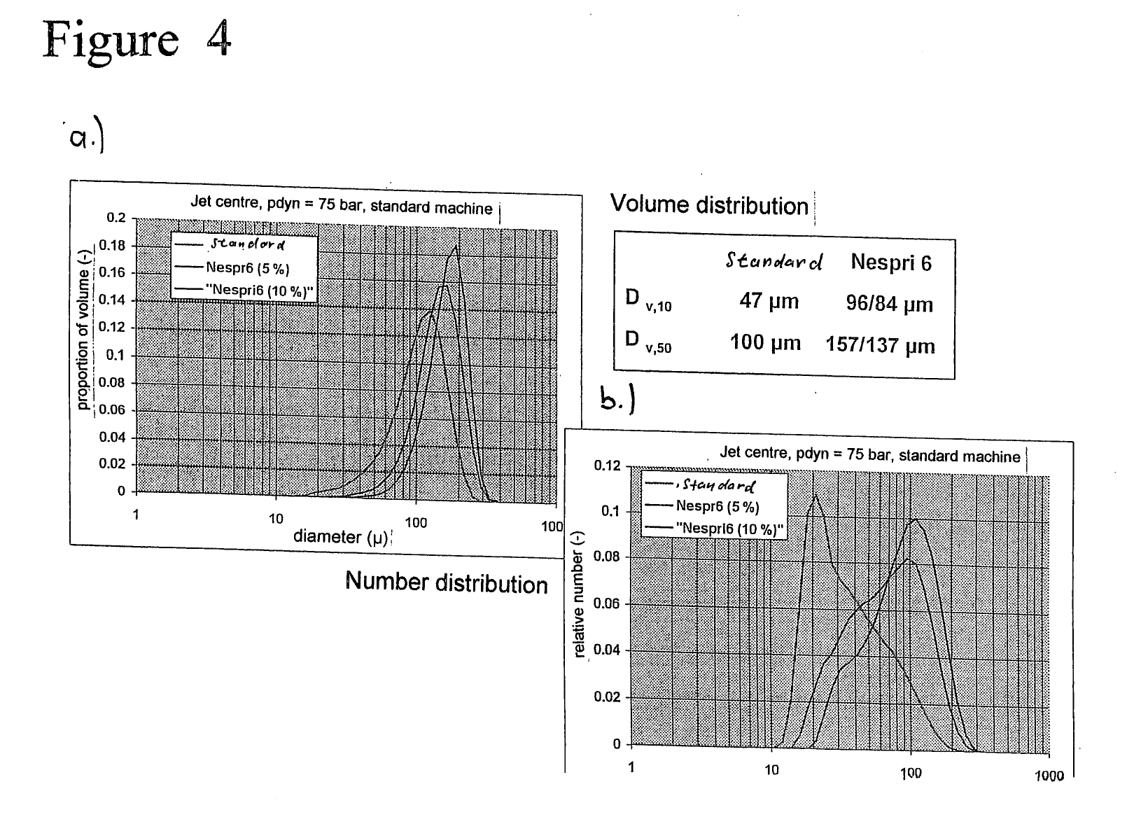

FIG. 4 shows again the comparison between a paint of the prior art and the paint according to the invention in respect of the volume distribution of the droplets formed and the number of the droplets, and

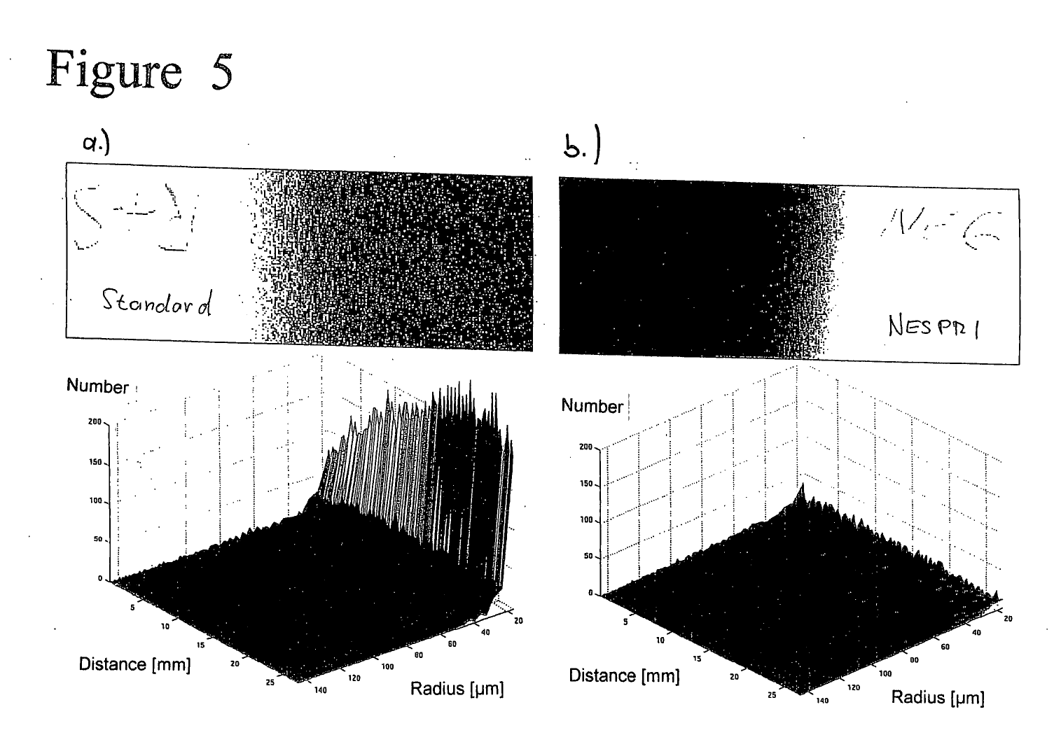

FIG. 5 shows an evaluation of spray patterns of a paint according to the invention and of a paint of the prior art.

Reproduced below is a starting formulation of a paint according to the invention which is referred to hereinafter as “NESPRI”.

NESPRI - Starting Formulation

| | | % by weight |
|---|---|---|
| Binding agents | | 12 |
| | acrylic resin, in | |
| | dispersion | |
| | silicone resin, in | |
| | dispersion | |
| Pigments | | |
| | titanium dioxide | 12 |
| Fillers | | 41 |
| | kaolin | |
| | mica | |
| | talcum | |
| | calcium carbonates | |
| Dispersants | | 0.4 |
| | polycarboxylates | |
| Thickeners | | 0.4 |
| | polycarboxylates | |
| Additives | | 1.6 |
| Preservatives | | 0.1 |
| | water | 32.5 |

FIG. 1 shows schematically the structure of a device for carrying out the method according to the invention. The device comprises a reservoir, designated as 1, in the form of a paint bucket. The dispersion paint is here conveyed from the paint bucket 1 via a feed line 5 by means of a diaphragm pump as the paint conveying device. It is essential for the method according to the invention that the paint taken from the paint container 1 by means of the diaphragm pump be led via a connecting line 3 to the airless spray gun 4, the connecting line 3 being in the form of a heated hose. This can be recognised symbolically by the structures depicted in FIG. 3. In the method according to the invention it is essential that the process be so managed that a spraying pressure, measured at the airless spray gun 4, of 55-135 bar, preferably 70-80 bar, is set. It is also important that, to ensure the physical properties, the temperature of the paint in the connecting line 3, i.e. in the hose, is so controlled that the viscosity range is not substantially influenced by the operating pressure and the ambient temperature. To this end, it is necessary to carry out preliminary heating, with the proviso that the temperature, measured at the airless spray gun, is in the range between 27 and 40°, by particular preference in the range between 30 and 38° C. Insofar as these conditions are maintained, an optimum droplet size formation is achieved. It is also essential that the airless spray gun 4 has a double nozzle. The geometry and the arrangement of the double nozzle is here to be selected such that spray jets intersect in the longitudinal direction. It has proved to be advantageous here if the double nozzle is designed in the form of two slit-like nozzle apertures arranged in a row.

FIG. 2 shows the comparison of the mean value Dᵥ₁₀ of the paint NESPRI6 according to the invention with a paint of the prior art. As FIG. 2 shows, the paint according to the invention is in all tested pressure ranges 55, 75 and 135 bar clearly superior to the paints of the prior art in respect of the mean value Dᵥ₁₀. The mean value Dᵥ₁₀ is here so defined that 10% of the total volume is present as droplets which are smaller than or equal to the given value. The painting according the invention shows mean values Dᵥ₁₀ which are larger by comparison with the paints of the prior art, this indicates a considerable reduction in fine components. The droplet size is quoted in μm (0-80).

FIG. 3 shows the comparison of the paint NESPRI6 according to the invention in two dilutions, namely at 10% and 5%, again with a paint of the prior art in respect of shear viscosity as a function of a preset shear rate range. As emerges clearly from the figure, the paint according to the invention has considerably higher viscosities in the shear rate range between 1 E⁰⁴ and 1.5 E⁰⁵. This has a positive effect on the spraying method described above.

FIG. 4 shows on the one hand in 4a, the volume distribution of the paint NESPRI6 and a paint of the prior art and FIG. 4b shows the number of droplets again for the two paints mentioned above. The definition of Dᵥ₁₀ and Dᵥ₅₀ corresponds to the one quoted under FIG. 1, the number of droplets being illustrated in FIG. 4b.

FIG. 5 shows the evaluation of the spray patterns in respect of the overspray. What was here evaluated was not the droplets but the spray pattern generated by the spraying. FIG. 5 here shows the superior properties of the paint according to the invention if it is applied by means of the claimed method. The depicted graph in FIG. 5a shows the spray pattern using a paint of the prior art. From the graph can be recognised both the number of the splashes evaluated on the spray pattern and their spacing from the imaginary zero line and the radius. From FIG. 5a it becomes clear that the paints of the prior art generate an overspray by very small paint dots which are substantially between 20 and 40 μm.

Surprisingly with the paint according to the invention it is now possible to eliminate this overspray practically completely. Both from the graph and from the image of the spray pattern arranged above it, it becomes clear that practically complete elimination of the overspray is achieved by the paint according to the invention in conjunction with the application method.

From FIG. a) can be clearly recognised that the diameter of the droplets which are realised with the paint according to the invention is significantly larger, under the same test conditions, than those which are achieved with a paint of the prior art. The difference is even clearer if the number of droplets, as can be recognised in FIG. 4b, is taken into account. From this emerges the fact that the paint according to the invention, in this example NESPRI6, has a mist formation which is reduced by up to 85%.

1. A paint based on at least one polymer dispersion with pigments, fillers, thickeners, dispersants and additives, wherein it contains:
a) 2-20 wt-% polymer dispersion calculated as a solid component,
b) 2-35 wt-% pigments,
c) 5-60 wt-% fillers having a particle diameter of 0.1-200 μm
d) 0.1-3 wt-% thickeners,
e) 0.1-2 wt-% dispersants, and
f) a maximum of 5 wt-% additives and water to make up to 100%, with the proviso that the dispersion has a viscosity of 2.0 to 5·10² m Pa/s, the viscosity being determined at a shear rate of 30,000·1/s with a capillary rheometer.

2. The paint according to claim 1, wherein the viscosity is in the range from 3.5 to 5.0·10² m Pa/s.

3. The paint according to claim 1, wherein the polymer dispersion is selected from polymers which have been obtained from the monomers carboxylic acid vinyl esters having 3-20 carbon atoms, N-vinylpyrrolidone, ethylenically unsaturated carboxylic acids, their esters, amides or anhydrides, styrene or its derivative, and/or α-olefins.

4. The paint according to claim 3, wherein it is a polystyrene acrylate, acrylic resin and/or silicone resin dispersion.

5. The paint according to claim 1, wherein the pigments are selected from titanium dioxide, iron oxide, chromium oxide, cobalt blue, phthalocyanine pigments, spinel pigments as well as nickel and chromium titanate, azoic pigments, quinacridone pigments and/or dioxazine pigments.

6. The paint according to claim 5, wherein the pigment is titanium dioxide.

7. The paint according to claim 1, wherein the fillers have a diameter of between 0.1 and 100 μm and are selected from silicates, carbonates, fluorite, sulphates and oxides.

8. The paint according to claim 1, wherein the surface of the fillers is functionalised.

9. The paint according to claim 1, wherein the thickener is selected from polycarboxylates, urethane thickeners, polysaccharides and/or cellulose ethers.

10. The paint according to claim 1, wherein the additives are dispersants, stabilisers, anti-foaming agents, preservatives and/or hydrophobing agents.

11. A method for applying paint, using a spraying process, wherein a dispersion paint according to claim 1 is led out of a reservoir via a conveying unit and a connecting line to an airless spray gun and sprayed at 55-135 bar spraying pressure measured at the spray gun.

12. The method according to claim 11, wherein the pressure is 70-80 bar.

13. The method according to claim 12, wherein a diaphragm pump is used as the conveying unit.

14. The method according to claim 12, wherein a temperature-controlled hose is used as the connecting line.

15. The method according to claim 14, wherein the temperature is so controlled that the dispersion paint has a temperature of 27-40° C., preferably 30-38° C., at the spray gun.

16. The method according to claim 11, wherein the airless spray gun is equipped with a double nozzle.

17. The method according to claim 16, wherein the double nozzle is designed in the form of two slit-like nozzle apertures arranged beside one another, preferably in a row.

18. The method according to claim 16, wherein the arrangement and design of the double nozzles is so selected that the spray jets intersect in the longitudinal direction.

19. (canceled)
